(19) United States
(12) Patent Application Publication
(10) Pub. No.: US 2017/0109351 A1
(43) Pub. Date: Apr. 20, 2017

(54) STATEFUL TAGS

(71) Applicant: Avaya Inc., Santa Clara, CA (US)

(72) Inventors: Ajita John, Holmdel, NJ (US); Seamus Hayes, Clarinbridge (IE); John Rix, Rahoon (IE); Adrian Ryan, Craughwell (IE); Samuel Fisher, Greenville, SC (US); David Skiba, Golden, CO (US)

(21) Appl. No.: 14/884,974

(22) Filed: Oct. 16, 2015

(51) Int. Cl. G06F 17/30

(52) U.S. Cl. CPC G06F 17/30038; G06F 17/30312; G06F 17/3005

(57) ABSTRACT

Tagging media streams allows topics and other items of interest to be readily identified. As provided herein, stateful tags are provided, which comprise a value determined from a link to another data source, such as a calendar, inventory, accounting, project management, or other application. Media streams, such as audio/video confines, may be tagged with stateful tags to identify items of interest and comprise a value that is dynamically determined. Subsequent playback of the media streams allows the stateful tags to be presented as comprising a then-current or other value, which may have changed since the time of the media stream's creation.

### FIELD OF THE DISCLOSURE

The present disclosure is generally directed toward electronic conferencing systems.

### BACKGROUND

Conference calls are a popular business tool to facilitate discussion between individuals at different locations to address various topics. The basic premise of a conference call is to discuss topics in a practical way when people are in different locations and may have time constraints. Conference calls often produce action items for one or more individuals. These action items need to be properly noted or remembered and, unless diligent transcription or note taking is provided, listening to a recording of the conference may be required in order to ensure actionable content has not been forgotten or unaddressed.

Tagging is one mechanism developed to improve the participants' ability to find actionable events in a conference. Despite the advantages of tagging, problems remain. For example, participants may still have to search (listen) for the action items associated with a particular tag. For a participant, such as a manager, wishing to ensure the action items of others have been addressed, the action item associated with a tag may require emails, phone calls, or searching through status reports.

### SUMMARY

It is with respect to the above issues and other problems that the embodiments presented herein were contemplated. By way of general introduction to the embodiments herein, stateful tags are disclosed that may be applied to audio/video conferences. Stateful tags may be mapped to actions and provide triggers to other systems. Stateful tags may also provide and/or receive updates for multi-dimensional dynamic interaction with stored audio/video conferences and conference participants.

In another embodiment, stateful tags allow conference data to incorporate dynamic values. As a user browses the recording, the tag values may be different at different times. This allows the data to be interpreted differently and allows the incorporation of data from other sources to be incorporated into the recordings. Stateful tags facilitate tag relationships that may be mined, discovered, and/or learned. Additionally, in a visualization of the conference, displaying the tags becomes more valuable with state descriptors during the meeting, during meeting playback, and as an interactive summary (e.g., red, yellow, green state, or percentage complete state, etc.).

Certain embodiments herein disclose stateful tags and further provide tag models for concepts such as action items. Tag models may then link conferencing solutions to other collaboration software to enable the dynamic updating of tags and/or tag attributes, which may further support improvements in system and human productivity.

In conferencing systems of the prior art, tags are used to index conferences, enable searches over a repository of conferences, and aid navigation within a conference. Data types assigned to tags enable aggregation and classification of the tags and the associated content. The tags of the prior art are also static and do not change once they are created. A viewer or listener to a recorded conference would encounter the tags as they existed when they were created.

In one embodiment, a state is assigned to a tag. The state of the tag may be represented by one or a set of variables. In one embodiment, the state of a tag may be an indicator of an event mapped to the tag. The set of variables, which model the tag, can be created by the author of the tag and/or inferred programmatically. A variable's value can be manually updated by a user and/or updated via an input received from another source, such as another application. Examples of how a stateful tag may be utilized include, but are not limited to the following:

1. A tag indicating an action item. The variables for the tag can be a STATUS variable (e.g., not started, started, completed, etc.), ASSIGNEE (e.g., person who is responsible for the action item), and completion TIMELINE (e.g., date or dates corresponding to the STATUS variable).

2. A tag represents the state of a document in the repository. The variables for the tag can be STATUS (e.g., created, updated, completed, etc.) and AUTHOR.

3. A tag represents the state of an inventory item or a workflow state.

In one embodiment, when stateful action item tags are created during a conference, the stateful tags may be automatically extracted into collaboration software (e.g., document sharing application, wiki pages, etc.), where their status will indicate to team members what their respective action items are, due dates, etc. Reminders may then be automatically generated and sent out to team members for action items, depending on the state, and the action items can be tracked based on their state. Users can click on the action items from the collaboration software to play a relevant part of the conference to gain more contextual information about the action item. This integrates conferencing solutions with collaboration software and improves productivity. Stateful tags can also indicate to supervisors when project deadlines have and have not been met.

In one embodiment, a server is disclosed, comprising: a microprocessor that accesses a media stream; the microprocessor stores the media stream; a data storage, accessible to the microprocessor, that stores the recorded media stream; the microprocessor, upon receiving a tag creation input signal, creates a tag comprising a dynamic state variable and associates the tag with the recorded media stream; and wherein the data storage maintains the value of the dynamic state variable as a link to a secondary data source.

In another embodiment, a method is disclosed, comprising: accessing a media stream; recording the media stream; storing the recorded media stream in a data storage; in response to receiving a tag creation input signal, creating a tag comprising a dynamic state variable; and storing in the data storage the tag comprising a value of the dynamic state variable determined by a link to a secondary data source.

In another embodiment, a method is disclosed, comprising: receiving a request to present a recorded media stream; accessing the recorded media stream comprising a tag with value determined by a link to a secondary data source; accessing the secondary data source; and playing back the recorded media stream and presenting the tag with the value of the accessed secondary data source.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts the recording of a live media stream in accordance with embodiments of the present disclosure;

FIG. 2 depicts the playback of a live media stream in accordance with embodiments of the present disclosure;

FIG. 3 depicts a system in accordance with embodiments of the present disclosure;

FIG. 4 depicts an application window in accordance with embodiments of the present disclosure;

FIG. 5 depicts a first process in accordance with embodiments of the present disclosure; and

FIG. 6 depicts a second process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

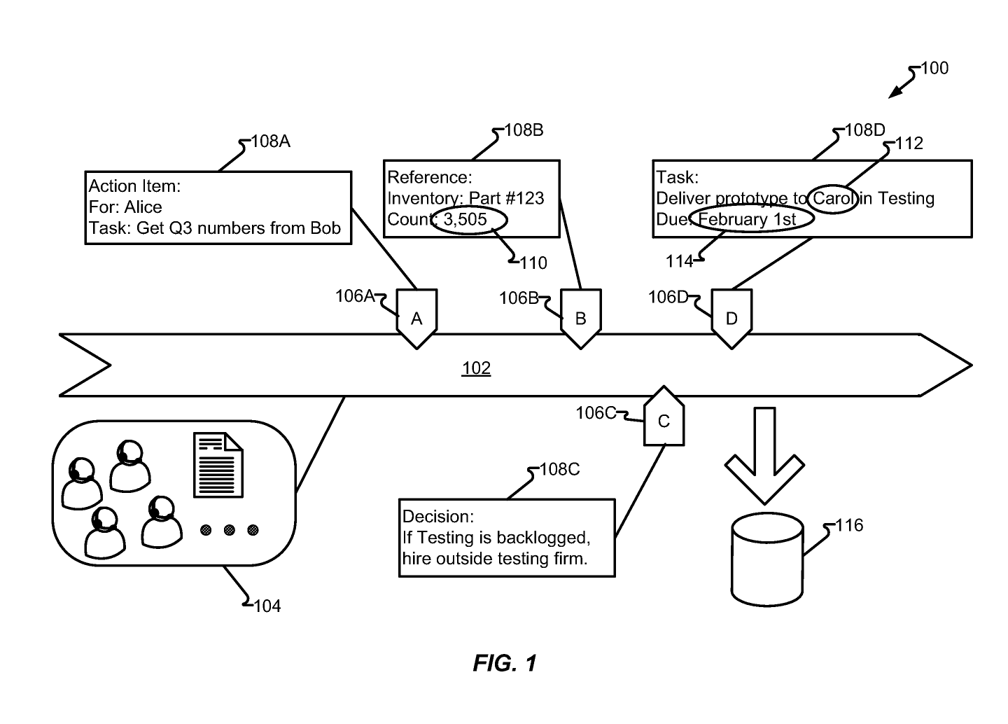

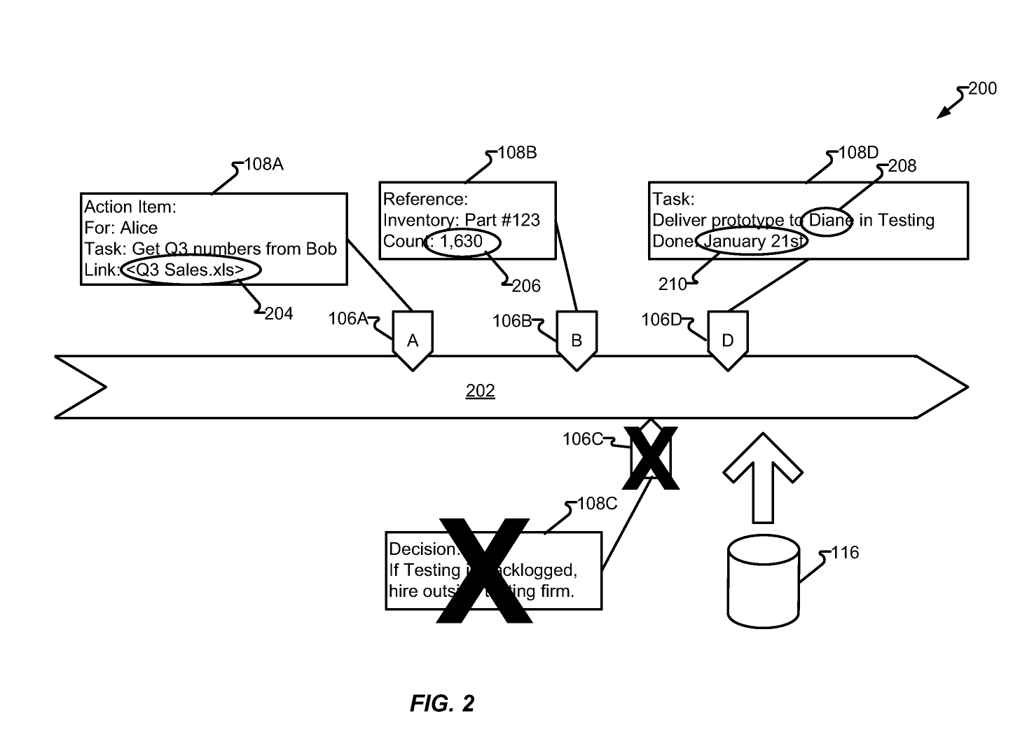

FIG. 1 depicts the recording of live media stream 102 in accordance with embodiments of the present disclosure. In one embodiment, diagram 100 illustrates live media stream 102, such as a teleconference, comprising a number of users and a number of communication endpoints (hereafter, “conference”). Media stream 102 may comprise content from a number of sources 104. Sources 104 may be one or more human participants, documents, other recordings (audio, video, co-browsing, etc.), or other content provided to live media stream 102. Data storage 116 stores the live media stream 102 as a recorded media stream (see FIG. 2).

In one embodiment, during the course of live media stream 102, a number of tags 106 are provided identifying relevant portions of live media stream 102. Relevancy may be provided by any one or more participants and/or automated components, such as upon the detection of a keyword or phrase. Tags 106 may be staple tags in that at least one data element is determined dynamically by reference to another data source.

In one embodiment, tag 106A comprises description 108A. As will be described in greater detail with respect to FIG. 2, description 108A comprises an action item, such as for one of the conference participants. Description 108A comprises a data field (not shown), which will be populated at a time following the creation of the tag, such as upon conclusion of the conference associated with live media stream 102.

In another embodiment, tags 106B and 106D are provided with descriptions 108B and 108D, respectively. Descriptions 108B and 108D comprise stateful elements, which are dynamically updated via a link to a secondary data source. As used herein, a secondary data source may be more authoritative, more accurate, or otherwise known to be a repository for a particular fact. The secondary data source may be an inventory system, time management system, project management system, spreadsheet, document, webpage, and/or any other source identified by at least one party, human or automated, as possessing a pertinent fact.

For example, description 108B comprises value 110, which is dynamically provided via a link to an inventory system (not shown). A human operator may manually create the link; however, in other embodiments, an automated system, such as one detecting reference to a particular element within an inventory system (“Part #123”) and automatically identifying the secondary source, and relative position within the secondary source, for an inventory count for the particular item, may establish a link thereto.

In another example, description 108D comprises values 112 and 114, each of which represents the value retrieved from a secondary data source, which may be the same data source, a different data source, or a different element within the same data source, to provide their respective values within description 108D associated with tag 106D. In this example, a contact is identified for testing a task and is displayed as value 112, such as may be retrieved from an organizational chart or human resource management system. A date is identified and displayed as value 114, such as may be retrieved from a contract, project management system, calendar, project plan, etc.

In another embodiment, tags 106 may have a limited lifespan. The future playback of live media stream 102 may cause tag 106C and description 108C to be omitted from the playback. The omission may be due to the occurrence of an extinction event, which would make the existence of tag 106C unnecessary. The extinction event may be a manually entered or automatically determined event (e.g., occurrence of a calendar event or the passage of time, etc.). In Response, tag 106C may be deleted or omitted from the presentation associated with the recorded stream of tag 106C.

Data storage 116 then stores live media stream 102 and tags 106. Data storage 116 may be a single data storage device, file, database, data structure, or a more complex storage system, such as a plurality of databases, appliances, sources, etc. For example, data storage 116 may comprise a sub-database for the storage of the media portion of live media stream 102 and a second sub-database for the storage of tags 106 and their associated links to their respective secondary data sources. It should be appreciated by those of ordinary skill in the art that other storage paradigms, including on-site and off-site and Internet-based “cloud” storage, may also be implemented without departing from the disclosure provided herein.

FIG. 2 depicts the playback of recorded media stream 202 in accordance with embodiments of the present disclosure. In one embodiment, diagram 200 illustrates recorded media stream 202 retrieved from data storage 116 for playback. The playback of recorded media stream 202 may be provided to any one or more endpoints, such as a personal computer, smart phone, tablet, etc., utilizing a media stream playback application accessing recorded media stream 202 from data storage 116.

In one embodiment, recorded media stream 202 occurs following tags 106 becoming updated via their respective links to their respective secondary data sources. In another embodiment, recorded media stream 202 presents tags 106, which are updated at the point at which they are accessed or presented in the playback of recorded media stream 202.

In another embodiment, tag 106A having description 108A comprises a link to a document associated with a particular task (action item). Subsequent playback of recorded media stream 202 allows the viewer to select the link provided by value 204 and access the document referenced. In other embodiments, such as with respect to tag 106B and associated description 108B, a particular value is inserted into the description. For example, value 206 has been updated to reflect the change in the inventory count for a particular item. Similarly, values 208 and 210 have been updated with their respective links to their respective secondary data sources to present to the viewer recorded media stream 202 with the values as they now currently exist.

In another embodiment, tag 106C and associated description 108C have been omitted from the playback of recorded media stream 202 upon the occurrence of an extinction event. In one embodiment, tag 106C no longer exists. However, in another embodiment, tag 106C comprises an attribute that when set causes tag 106C and associated description 108C to not be provided during the playback of recorded media stream 202. In this way, events that are deemed no longer relevant or confidential may be excluded from all future playback or playback for certain users.

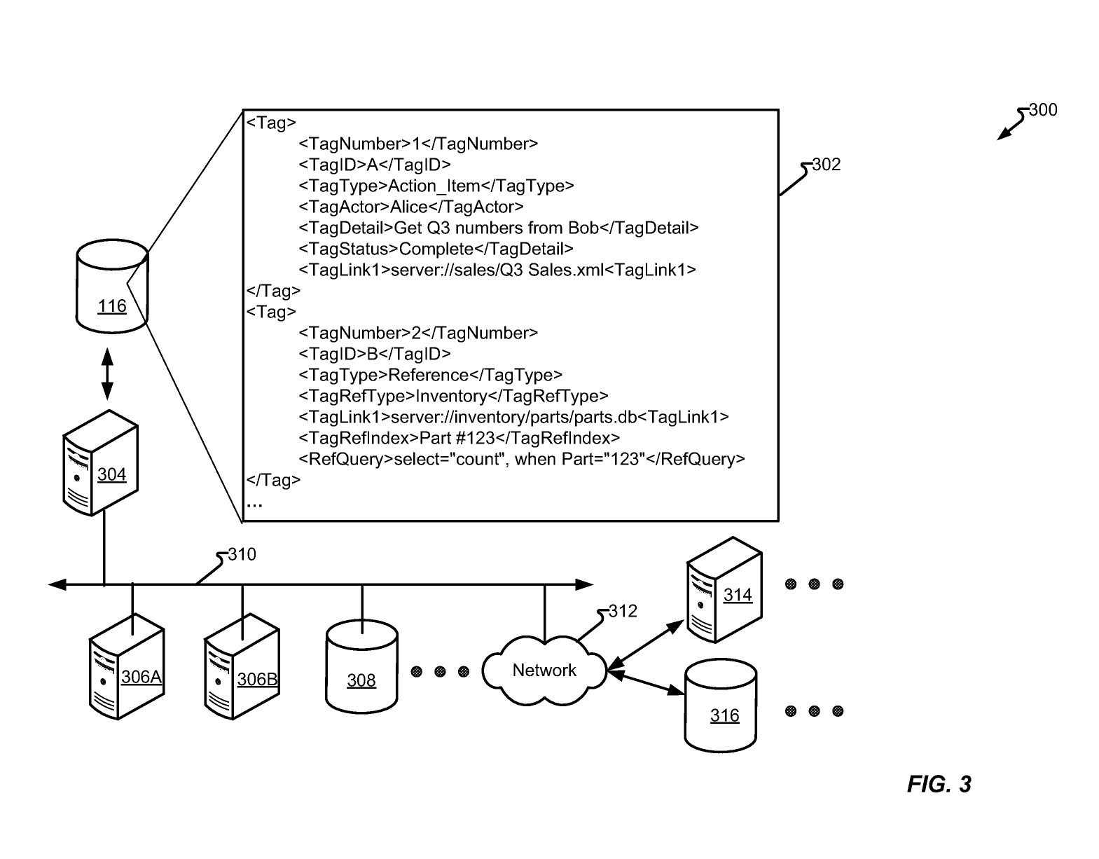

FIG. 3 depicts system 300 in accordance with embodiments of the present disclosure. In one embodiment, system 300 comprises server 304. Server 304 may be tasked with serving a recorded media stream, such as recorded media stream 202, having tags 106 stored in data storage 116. Server 304 may optionally record a live media stream, such as media stream 102, for storage in data storage 116 or other storage medium. In one embodiment, tag data 302 is provided in an extensible markup language (XML) format. In other embodiments, tag data 302 may be provided as a flat file, data record, database, plurality of the foregoing, and/or other data storage devices or systems. Tag data 302 maintains visual portions to be displayed during the playback of recorded media stream 202 as well as links to secondary data sources enabling tag state data presented to be updated based upon accessing the secondary data sources and the value associated with a link of a tag 106.

Tag data 302 may provide additional data for one or more tags 106. For example, a temporal indicator, such as a time, within recorded media stream 202 associated with one of tags 106. Additional data elements may also be provided as a matter of design choice, such as a custom or application-specific attribute, timeframe, deadline, contact information, responsible party, etc.

System 300 may further comprise a communications network 310 providing communication and data exchange between computing devices 306 and storage devices 308. In one embodiment, at least one of computing devices 306 and storage devices 308 are associated with another application, such as an accounting system, project management system, calendaring system, etc., which may in turn access saved media stream 202. Server 304, such as via internal network 310, may access secondary network 312 (e.g., Internet, additional network, etc.). Via secondary network 312, secondary computer and/or server 314 and/or data storage 316 may be made available to send and receive data to/from server 304.

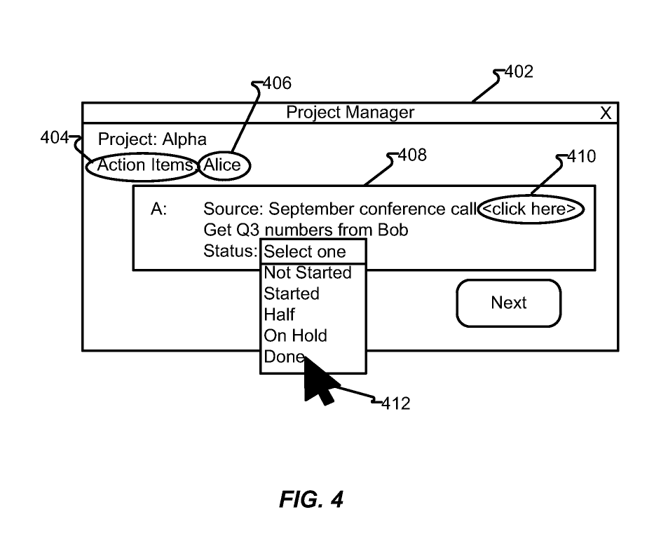

FIG. 4 depicts application window 402 in accordance with embodiments of the present disclosure. In one embodiment, window 402 is a portion of an application different from the hosting, capturing, and playback of a media stream. For example window 402 may be a portion of a project management application.

In one embodiment application window 402 manages a particular task or element associated with the content of a media stream, such as recorded media stream 202. Application window 402 may be further associated with one of tags 106. For example, window 402 comprises a tag attribute (action items) 404 and an associated user 406 (Alice). The source of the action item may be identified in task detail 408 as having originated from a conference captured as a media stream. Link 410 may provide an index to stored media stream, such as stored media stream 202, or a particular location within a stored media stream associated with the creation of the task and its associated tag.

In another embodiment, a tag, such as tag 106A, comprises a state in that at least a portion thereof is associated with a variable set by an input upon application window 202. For example, a user selecting a particular status update 412 may then be saved and the location accessed by a link, which is further associated with tag 106A. Upon playback of stored media stream 202, tag 106A presents the value as it currently exists in the accessible location.

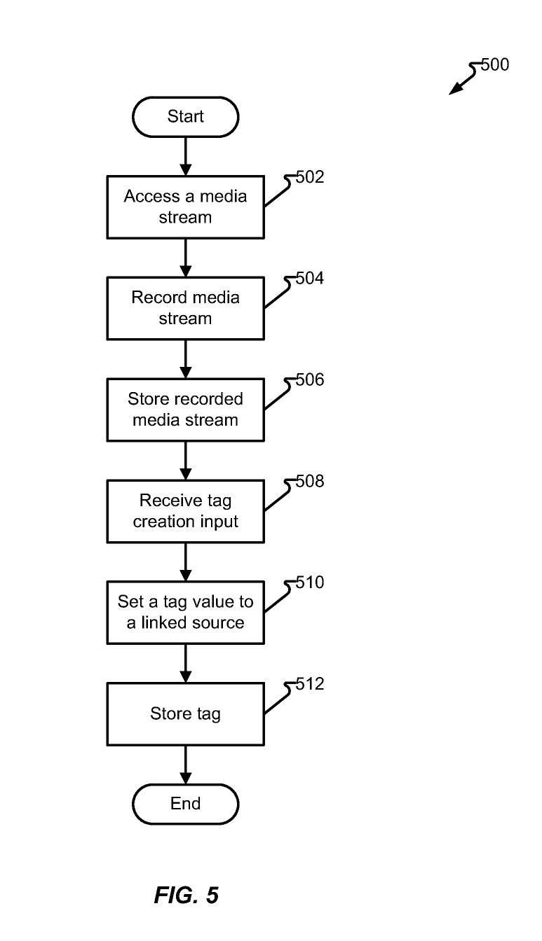

FIG. 5 depicts process 500 in accordance with embodiments of the present disclosure. In one embodiment, process 500 begins at step 502 wherein the media stream is accessed. The media stream may be accessed such as by server 304 hosting a teleconference between a number of endpoints and their associated number of users. Step 504 records the media stream, such as by capturing the output of the content of a conference for storage within data storage 116, for example, at step 506.

In one embodiment, step 508 creates a tag upon receiving an input from the user, such as a participant in a conference associated with the accessed media stream. In another embodiment, step 508 creates a tag upon an automated voice recognition system detecting a keyword or phrase associated with the stateful tag. Step 510 associates the tag value to a link source, such as a database or other secondary data source, providing the value to be displayed upon subsequent playback of the media stream. Step 510 may be conducted in real time, or substantially real time, or following completion of the creation of the media stream.

Step 512 stores the tag, such as in data storage 116 and optionally stores, in the same location or elsewhere, the accessed media stream.

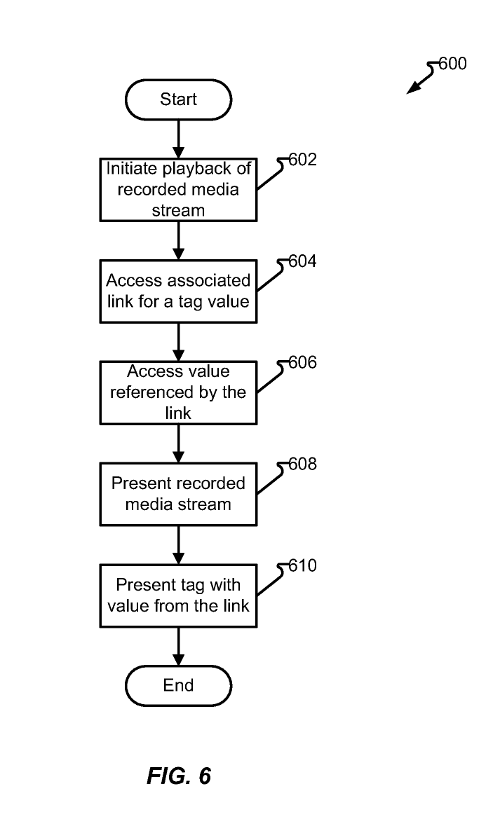

FIG. 6 depicts process 600 in accordance with embodiments of the present disclosure. In one embodiment, process 600 initiates playback at step 602 of a recorded media stream. In one embodiment, step 602 is performed by a user initiating a conference playback recorded as a recorded media stream 202 maintained in data storage 116. The recorded media stream has at least one stateful tag, such as one of tags 106. Step 604 accesses the associated link for the stateful tag. Step 606 accesses the value referenced by the link retrieved in step 604.

Step 608 presents the recorded media stream and step 610 presents the tag comprising a value as determined from the link.

In another embodiment, at least one of tags 106 is integrated into and/or interact with another applications and systems, such as those providing project management, team management, reporting, etc. Tag 106 may then be updated from inputs received via such other applications and systems and updates received and/or generated by the other applications and systems.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A server, comprising:
a microprocessor that accesses a media stream;
the microprocessor stores the media stream;
a data storage, accessible to the microprocessor, that stores the recorded media stream;
the microprocessor, upon receiving a tag creation input signal, creates a tag comprising a dynamic state variable and associates the tag with the recorded media stream; and
wherein the data storage maintains the value of the dynamic state variable as a link to a secondary data source.

2. The server of claim 1, wherein upon receiving a signal associated with a request to access the stored media stream, the microprocessor:
accesses the media stream stored in the data storage;
accesses the link to the second data source;
retrieves the value of the dynamic state variable from the secondary data source; and
presents the accessed media stream stored in the data storage comprising the tag with the value of the dynamic state variable as retrieved from the secondary data source.

3. The server of claim 1, wherein, the microprocessor accesses the recorded media stream in the data storage for playback, the playback further comprising presenting the tag with the value of the dynamic state variable determined by the link to the secondary data source.

4. The server of claim 3, wherein a temporal indicia is provided to provide temporal context of the tag.

5. The server of claim 4, wherein the playback comprises presenting the tag at a time during the playback associated with the temporal indicia.

6. The server of claim 1, wherein the media stream comprises a teleconference between a number of participants.

7. The server of claim 1, wherein the tag further comprises indicia of a task and the secondary data source comprises a task management data source.

8. The server of claim 1, wherein the tag further comprises an extinction event whereby a playback of the media stream, after the occurrence of an event satisfying the extinction event, causes the playback to omit presentation of the tag.

9. The server of claim 1, wherein the dynamic state variable comprises a plurality of dynamic state variables.

10. The server of claim 1, wherein the data storage is accessible to logically connected components externally located to the server.

11. A method, comprising:
accessing a media stream;
recording the media stream;
storing the recorded media stream in a data storage;
in response to receiving a tag creation input signal, creating a tag comprising a dynamic state variable; and
storing in the data storage the tag comprising a value of the dynamic state variable determined by a link to a secondary data source.

12. The method of claim 11, wherein the tag creation input signal is manually initiated.

13. The method of claim 11, further comprising:
receiving a text input from a user;
parsing the text input to identify a context;
identify a link associated with the context; and
automatically provide the identified link as the link to the secondary data source.

14. The method of claim 11, wherein the tag comprises at least one human-readable indicia.

15. A method, comprising:
receiving a request to present a recorded media stream;
accessing the recorded media stream comprising a tag with value determined by a link to a secondary data source;
accessing the secondary data source; and
playing back the recorded media stream and presenting the tag with the value of the accessed secondary data source.

16. The method of claim 15, further comprising:
determining an extinction event has occurred; and
wherein the tag comprises an extinction attribute that, upon the occurrence of the extinction event, causes the presentation of the recorded media stream to omit the tag.

17. The method of claim 15, further comprising:
receiving an update input for the tag;
utilizing the link to access the secondary value; and
updating the value in the secondary source associated with the tag in accord with the update input.

18. The method of claim 17, further comprising:
identifying a user associated with the tag; and
signaling the user associated with the tag in accord with the updating step.

19. The method of claim 15, further comprising:
receiving an update input for the tag;
annotating the tag in accord with the update input; and
saving the annotated tag in the data storage.

20. The method of claim 15, further comprising:
wherein the step of receiving the request to present a recorded media stream comprises executing another application different from an application utilized to present the recorded media stream and receiving the request comprising a user input upon another application.
